(19) United States
(12) Patent Application Publication
(10) Pub. No.: US 2024/0146646 A1
(43) Pub. Date: May 2, 2024

(54) EDGE PLATFORM MANAGEMENT DEVICE, METHOD FOR OPERATING EDGE PLATFORM MANAGEMENT DEVICE, AND EDGE GATEWAY DEVICE

(71) Applicant: SK TELECOM CO., LTD., Seoul (KR)

(72) Inventor: Min Cheol PARK, Seoul (KR)

(21) Appl. No.: 18/289,254

(22) PCT Filed: Jul. 4, 2022
(86) PCT No.: PCT/KR2022/009605

§ 371 Date: Nov. 2, 2023

(30) Foreign Application Priority Data
Jul. 28, 2021 (KR) 10-2021-0099106

(51) Int. Cl. H04L 45/586; G06F 9/455; H04L 61/103; H04L 61/2596; H04L 61/5007

(52) U.S. Cl. CPC H04L 45/586; G06F 9/45533; H04L 61/103; H04L 61/2596; H04L 61/5007

(57) ABSTRACT

The present disclosure relates to an edge platform management device, an operating method of edge platform management device, and an edge gateway device which suggest an efficient connection method between a Layer 2 (L2)-based switch and a Layer-3 (L3)-based traffic-processing gateway node in a mobile-edge computing (MEC) environment.

### TECHNICAL FIELD

The present disclosure relates to an efficient connection between a Layer 2 (L2)-based switch and a Layer-3 (L3)-based traffic-processing gateway node in a mobile-edge computing (MEC) environment.

The present application claims the benefit of priority to Korean Patent Application No. 10-2021-0099106 filed on Jul. 28, 2021 in the Korean Intellectual Property Office, the entire disclosure of which is incorporated herein by reference.

### BACKGROUND ART

Serverless computing is a form of service in which all elements except an application are provided by a cloud provider and in the serverless computing service, except for applications, physical infrastructure, virtual machines, containers, and integrated management areas are serviced by cloud providers, and users can manage applications.

Among the components described above, the container is a virtualization technique much lighter than a virtual machine (VM) and may configure and operate all elements related to application execution in one package.

The container may have a capacity relatively smaller than that of the virtual machine, which may reduce the time required for developers to produce and distribute the container, and has the advantage of being able to restart quickly.

In a mobile-edge computing (MEC) environment, which is to provide various IT services and technologies having been provided in a conventional cloud environment at an edge of mobile networks, support for the aforementioned virtual resources including the container is also required.

In accordance with the requirement, in the mobile edge computing environment, a virtual network is established in an edge platform by connecting virtual machines including Kubernetes-based containers (PODs) and customer-specific services are provided.

In this regard, in the mobile edge computing environment, Layer 3 (L3)-based traffic-processing gateway nodes are connected to a Layer 2 (L2)-based switch (physical switch) in the edge platform for supporting Internet traffic-processing for virtual machines.

However, since Internet traffic is processed by connecting an L2-based switch and an L3-based traffic-processing gateway node in the mobile edge computing environment, when a routing path change for Internet traffic is required in the edge platform, there is a limitation that the existing routing protocol cannot be applied.

### DISCLOSURE OF INVENTION

### Technical Problem

Therefore, the present disclosure has been made in view of the above-mentioned problems, and an aspect of the present disclosure is to suggest an efficient connection between a Layer 2 (L2)-based switch and a Layer-3 (L3)-based traffic-processing gateway node in a mobile-edge computing (MEC) environment.

### Solution to Problem

To this end, an edge platform management device according to an embodiment of the present disclosure is configured to include an identification part configured to identify, when a routing event occurs in relation to Internet traffic-processing of a virtual machine (VM) in an edge platform, an edge gateway device configured to process Internet traffic for the virtual machine and a management part configured to transfer an event message according to the routing event to a switch configured to route, on the basis of the event message, Internet traffic in the edge platform through the edge gateway device and update a routing table being managed for a routing operation in the switch.

Specifically, the routing event may include a case in which a specific floating IP address is allocated to a first virtual machine in order to support Internet traffic-processing of the first virtual machine in the edge platform, or the specific floating IP address having been allocated to the first virtual machine is re-allocated to a second virtual machine different from the first virtual machine.

Specifically, the management part may be configured to map the specific floating IP address and a MAC address of the first virtual machine within the routing table through the event message or update a MAC address mapped to the specific floating IP address from the MAC address of the first virtual machine to a MAC address of the second virtual machine.

Specifically, the routing event may include a case in which an edge gateway device configured to process Internet traffic for the virtual machine is changed from a first edge gateway device to a second edge gateway device different from the first edge gateway device.

Specifically, the management part may be configured to transfer the event message through the second edge gateway device and update an edge gateway device configured to process Internet traffic of the virtual machine from the first edge gateway device to the second edge gateway device within the routing table.

Specifically, the event message may include a gratuitous ARP (GARP) message that may update information recorded in the routing table using MAC address and IP address in a message field.

To this end, the edge gateway device according to an embodiment of the present disclosure is configured to, when a routing event occurs in relation to Internet traffic-processing of a virtual machine (VM) in an edge platform, transfer an event message according to the routing event received from the edge platform management device to a switch and cause the switch to update a routing table being managed for a routing operation, on the basis of the event message.

Specifically, the routing event may include at least one of a case in which a specific floating IP address is allocated to a first virtual machine in order to support Internet traffic-processing of the first virtual machine in the edge platform, or the specific floating IP address having been allocated to the first virtual machine is re-allocated to a second virtual machine different from the first virtual machine and a case in which a device configured to process Internet traffic for the virtual machine is changed from another edge gateway device to the edge gateway device.

To this end, an operating method of an edge platform management device according to an embodiment of the present disclosure includes an identification operation of identifying, when a routing event occurs in relation to Internet traffic-processing of a virtual machine (VM) in an edge platform, an edge gateway device configured to process Internet traffic for a virtual machine and a management operation of transferring an event message according to the routing event to a switch configured to route Internet traffic in the edge platform through the edge gateway device and updating, on the basis of the event message, a routing table being managed for a routing operation in the switch.

Specifically, The routing event may include a case in which a specific floating IP address is allocated to a first virtual machine in order to support Internet traffic-processing of the first virtual machine in the edge platform, or the specific floating IP address having been allocated to the first virtual machine is re-allocated to a second virtual machine different from the first virtual machine.

Specifically, in the management operation, the specific floating IP address and a MAC address of the first virtual machine are configured to be mapped within the routing table through the event message or a MAC address mapped to the specific floating IP address is updated from the MAC address of the first virtual machine to a MAC address of the second virtual machine.

Specifically, the routing event may include a case in which an edge gateway device configured to process Internet traffic for the virtual machine is changed from a first edge gateway device to a second edge gateway device different from the first edge gateway device.

Specifically, in the management operation, the event message may be configured to be transferred through the second edge gateway device and update an edge gateway device configured to process Internet traffic of the virtual machine from the first edge gateway device to the second edge gateway device within the routing table.

Specifically, the event message may include a gratuitous ARP (GARP) message that may update information recorded in the routing table using MAC address and IP address in a message field.

### Advantageous Effects of Invention

The edge platform management device, the operating method of the edge platform management device, and the edge gateway device of the present disclosure may suggest a new method for connection between a Layer 2 (L2)-based switch and a Layer 3 (L3)-based traffic-processing gateway node in a mobile-edge computing (MEC) environment and achieve an effect of enabling efficient response to changes in routing paths related to Internet traffic-processing without applying existing L3-based routing protocols.

### BRIEF DESCRIPTION OF DRAWINGS

FIG. 1 is an exemplary view illustrating a mobile-edge computing environment according to an embodiment of the present disclosure;

FIG. 2 is a schematic view illustrating an edge platform management device according to an embodiment of the present disclosure;

FIG. 3 is an exemplary view illustrating a structure of an edge platform according to an embodiment of the present disclosure;

FIGS. 4 to 6 are exemplary views illustrating a routing event situation according to an embodiment of the present disclosure; and

FIG. 7 is a flowchart illustrating an operating method of an edge platform management device according to an embodiment of the disclosure.

### BEST MODE FOR CARRYING OUT THE INVENTION

Hereinafter, a preferred embodiment of the present disclosure will be described with reference to accompanying drawings.

An embodiment of the present disclosure shows a mobile-edge computing technology in which a container, which is a virtual resource, is installed on a virtual machine (VM) to provide customer-specific services based thereon.

The mobile edge computing technology denotes a concept to provide various IT services and technologies to an edge of a mobile network and requires support for the container which is a virtual resource, as in existing cloud environments.

Here, the container is a virtualization technique much lighter than a virtual machine (VM) and may configure and operate all elements related to application execution in one package.

The container may have a capacity relatively smaller than that of the virtual machine, which may reduce the time required for developers to produce and distribute the container, and has the advantage of being able to restart quickly.

In this regard, most of the current services are composed of a microservice architecture based on Kubernetes indicating an open-source system that automatically distributes, scales, and manages a containerized application, and support for Kubernetes is essential in the above-described mobile edge computing environment as well.

In accordance with the requirement, in the mobile edge computing environment, a virtual network is established in an edge platform with an inter-VM connection structure including Kubernetes-based containers (PODs) and customer-specific services are provided on the basis of the network.

Meanwhile, in the mobile edge computing environment, multiple Layer 3 (L3)-based gateway nodes for processing traffic separate from a Layer 2 (L2)-based switch (physical switch) in the edge platform are provided to support Internet traffic-processing for virtual machines so as to be used in connection with the L2-based switch.

However, in the mobile edge computing environment, since a connection between an L2-based switch and an L3-based traffic-processing gateway node is required, when a routing path change for Internet traffic is required in the edge platform, there is a limitation that the existing routing protocol cannot be applied as it is to address the issue.

Of course, an existing L3-based routing protocol (e.g., BGP, and OSPF) may be applied for a connection between an L2-based switch and an L3-based traffic-processing gateway node.

However, to this end, due to a characteristic of a gateway node running on a server in a form of software, software should be separately purchased and accordingly, an additional issue such as maintenance and management of the software may occur.

In this regard, an embodiment of the present disclosure newly suggests a method for an efficient connection between an L2-based switch and an L3-based traffic-processing gateway node in a mobile-edge computing environment.

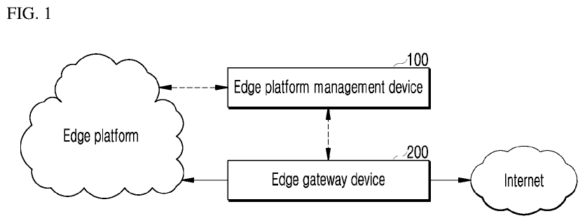

FIG. 1 illustrates a mobile-edge computing environment according to an embodiment of the present disclosure.

As shown in FIG. 1, in the mobile-edge computing environment according to an embodiment of the present disclosure, there may be a configuration including an edge platform management device 100 configured to manage a virtual network configured to have an inter-VM connection structure in an edge platform, and an edge gateway device 200 configured to support Internet traffic-processing related to virtual machines.

The edge platform management device 100 denotes a device configured to generate and control a virtual network by using the inter-VM connection structure including PODs, and may include a software-defined networking controller (SDN controller), for example.

The edge gateway device 200 denotes an L3-based traffic-processing gateway node provided to transfer Internet traffic between a virtual network and Internet when Internet connection of a VM is necessary, and may have a form configured to run on the basis of software in a server.

In the edge platform according to an embodiment of the present disclosure, it is possible to generate an internal network configured to support communication between virtual machines connected to a virtual LAN in a manner of connecting virtual machines to each other through the virtual LAN.

The edge platform according to an embodiment of the present disclosure may be configured to support communication between internal networks connected to a virtual router in a manner of interconnecting virtual LANs constituting the internal network through the virtual router.

Furthermore, the edge platform according to an embodiment of the present disclosure may be configured to connect an external network configured to support routing through an L2-based switch to a virtual router and then extend a communication area of a virtual machine for an Internet connection through the edge gateway device 200 to be supported.

The method for the efficient connection between the L2-based switch in the edge platform and the edge gateway device 200 which is the L3-based traffic-processing gateway node on the basis of the above-described configuration in the mobile-edge computing environment according to an embodiment of the present disclosure has been described above. Hereinafter, a configuration of the edge platform management device 100 to implement the method will be described in more detail.

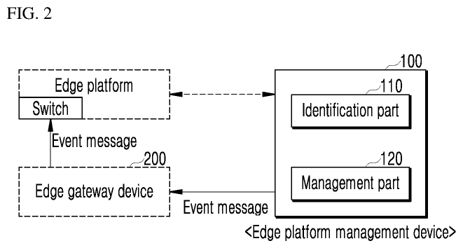

FIG. 2 illustrates a schematic configuration of the edge platform management device 100 according to an embodiment of the present disclosure.

As shown in FIG. 2, the edge platform management device 100 according to an embodiment of the present disclosure may be configured to include an identification part 110 configured to identify the edge gateway device 200 configured to process Internet traffic for a virtual machine according to routing event occurrence and a management part 120 configured to update a routing table of a switch in the edge platform.

The entire configuration or a partial configuration of the edge platform management device 100 configured to include the identification part 110 and the management part 120 may be implemented in a hardware module or a software module, or implemented in a form of combining a hardware module and a software module.

The software module may be construed as, for example, an instruction executed by a processor configured to process an operation within the edge platform management device 100, and the instruction may be configured to have a form mounted in a separate memory in the edge platform management device 100.

The edge platform management device 100 according to an embodiment of the present disclosure may be configured to provide a method for the efficient connection between the L2-based switch in the edge platform and the edge gateway device 200 which is the L3-based traffic-processing gateway through the above-described configuration. Hereinafter, a more detailed description of the configuration in the edge platform management device 100 to implement the method will be continued.

The identification part 110 is configured to perform a function of identifying the edge gateway device 200 configured to process Internet traffic for a virtual machine.

More specifically, when a routing event occurs in the edge platform, the identification part 110 may be configured to identify the edge gateway device 200 in charge of processing Internet traffic for a corresponding virtual machine.

Since a virtual machine is configured to operate as a server like a web server in the edge platform, most of same are inbound packets that access the virtual machine from the outside.

Accordingly, one public IP address among public IP bands included in the external network may be allocated to the virtual machine as a floating IP address in the edge platform.

Here, in case that an inbound packet is introduced, the edge gateway device 200 may be configured to perform an operation of converting the floating IP address configured as a destination address of the inbound packet into a private IP address of the virtual machine configured to have a mapping relationship with the address and transfer the private IP address.

The routing event situation that can be considered in one embodiment of the present disclosure is related to Internet traffic processing of a virtual machine and may be configured to include, for example, a case where a floating IP address for Internet traffic processing support is allocated or reallocated for a virtual machine, or the edge gateway device 200 configured to support Internet traffic processing for a virtual machine is changed.

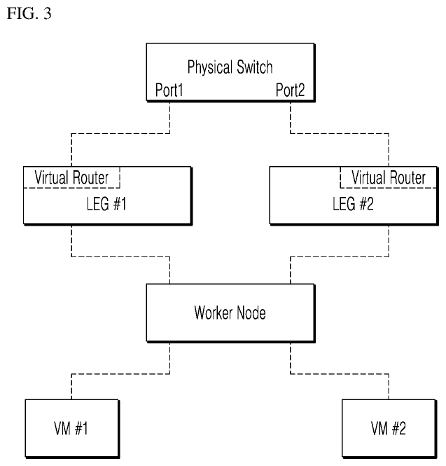

In this regard, as shown in FIG. 3, in the edge platform according to an embodiment of the present disclosure, a virtual router may be configured to exist to support communication between a first virtual machine VM #1 and a second virtual machine VM #2, and an internal network configured to include the first virtual machine and the second machine, and a first edge gateway device LEG #1 and a second edge gateway device LEG #1 may be configured to exist to support Internet traffic processing of the first virtual machine VM #1 and the second virtual machine VM #2.

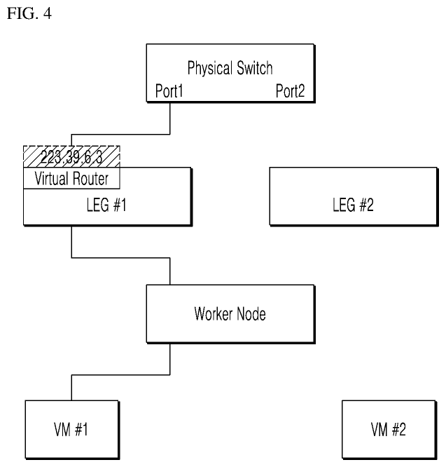

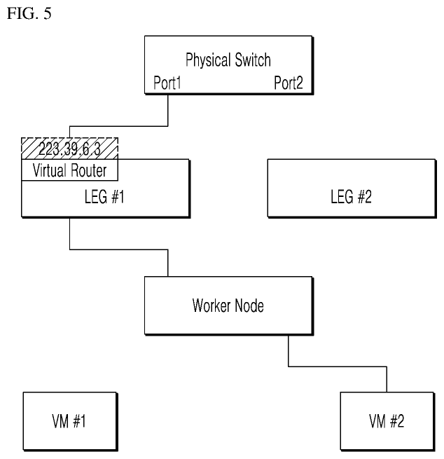

Here, it is possible to recognize a routing event situation in which a specific floating IP address (233.39.6.3) is allocated to the first virtual machine VM #1 to support Internet traffic processing of the first virtual machine VM #1 in the edge platform as shown in FIG. 4, or a specific floating IP address (233.39.6.3) pre-allocated to the first virtual machine VM #1 is re-allocated to the second virtual machine VM #2 different from the first virtual machine VM #1 as shown in FIG. 5.

Here, the first edge gateway device LEG #1 may be configured to be identified as the edge gateway device 200 configured to process Internet traffic for the first virtual machine VM #1 and the second virtual machine VM #2.

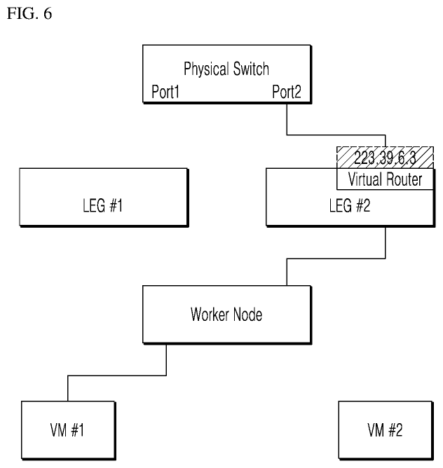

Furthermore, as shown in FIG. 6, a case in which the edge gateway device 200 configured to support Internet traffic processing of the first virtual machine VM #1 is changed from the first edge gateway device LEG #1 to the second edge gateway device LEG #2 due to a failure or the like may be recognized as a routing event situation as well.

In this case, the second edge gateway device LEG #2 may be configured to be identified as the edge gateway device 200 configured to process Internet traffic for the first virtual machine VM #1.

The management part 120 is configured to perform a function to update a routing table of a switch in the edge platform.

More specifically, when the edge gateway device 200 configured to process Internet traffic for a virtual machine is identified according to a routing event occurrence in the edge platform, the management part 120 is configured to transfer an event message according to a routing event to a switch in the edge platform through the identified edge gateway device 200 and update a routing table L2 Table being managed for routing Internet traffic by the switch, on the basis of the event message.

Here, the management part 120 may be configured to transfer, as an event message to update the routing table L2 Table being managed by the switch, a gratuitous ARP (GARP) message capable of updating information recorded in the message with a MAC address and an IP address in a message field, to the switch in the edge platform.

For better understanding, the updating procedure of the routing table L2 Table according to a type of a routing event will be described in detail below.

As shown in FIG. 4 above, it assumes a routing event situation in which a specific floating IP address (233.39.6.3) is allocated to the first virtual machine VM #1 to support Internet traffic processing of the first virtual machine VM #1 in the edge platform.

In case that the first edge gateway device LEG #1 for Internet traffic processing of the first virtual machine VM #1 is identified, by transferring a corresponding event message to the switch (physical switch) through the first edge gateway device LEG #1, it may cause the switch (physical switch) to map a specific IP address (233.39.6.3) and a MAC address of the first virtual machine VM #1 within the routing table L2 Table being managed.

Furthermore, it is possible to assume a routing event situation in which a specific floating IP address (233.39.6.3) pre-allocated to the first virtual machine VM #1 in the edge platform is re-allocated to the second virtual machine VM #2 different from the first virtual machine VM #1 as shown in FIG. 5 above.

In case that the second edge gateway device LEG #1 for Internet traffic processing of the second virtual machine VM #2 is identified, by transferring a corresponding event message to the switch (physical switch) through the first edge gateway device LEG #1, it may cause the switch (physical switch) to update a MAC address mapped to a specific floating IP address (233.39.6.3) within the routing table L2 Table being managed from the MAC address of the first virtual machine VM #1 to the MAC address of the second virtual machine VM #2.

It is possible to assume a case in which an event message is not transferred to a switch (physical switch) with respect to a routing event situation in which a specific floating IP address (233.39.6.3) pre-allocated to the first virtual machine VM #1 in the edge platform is re-allocated to the second virtual machine VM #2 different from the first virtual machine VM #1.

In this case, since the MAC address mapped to the specific floating IP address (233.39.6.3) is still considered as the MAC address of the first virtual machine VM #1 in the switch (physical switch), it may be predicted that packet drop is incurred and then Internet traffic for the second virtual machine VM #2 may be processed normally only after the existing information in the routing table is deleted by a timer (ARP timer) of the switch (physical switch) itself.

Furthermore, as shown in FIG. 6 above, it is also possible to assume an event situation in which the edge gateway device 200 configured to support Internet traffic processing of the first virtual machine VM #1 is changed from the first edge gateway device LEG #1 to the second edge gateway device LEG #2 due to a failure or the like.

Here, by transferring a corresponding event message to a switch (physical switch) through the second edge gateway device LEG #2, the switch (physical switch) may be caused to update the edge gateway device 200 configured to support Internet traffic processing of the first virtual machine VM #1 and the second virtual machine #2 within the routing table L2 Table being managed from the first edge gateway device LEG #1 to the second edge gateway device LEG #2.

As described above, according to the configuration of the edge platform management device 100 according to an embodiment of the present disclosure, a new connection method using the event message (GARP message) for connection between the L2-based switch and the edge gateway device 200 which is the L3-based traffic-processing gateway node in the mobile-edge computing (MEC) environment can be suggested and it may be seen that efficient response to changes in routing paths related to Internet traffic processing is possible without applying the existing L3-based routing protocol.

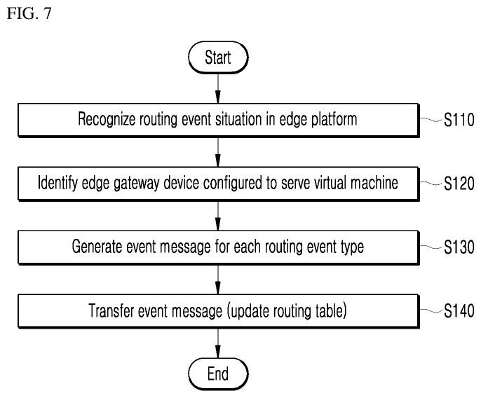

Hereinafter, an operating method of the edge platform management device 100 according to an embodiment of the present disclosure will be described with reference to FIG. 7.

First, when a routing event occurs in the edge platform, the identification part 110 may be configured to identify the edge gateway device 200 in charge of processing Internet traffic for a corresponding virtual machine (S110S-S120).

The identification part 110 may be configured to recognize, as a routing event situation, a case related to Internet traffic processing of a virtual machine, for example, a case where a floating IP address for Internet traffic processing support is allocated or reallocated for a virtual machine, or the edge gateway device 200 configured to support Internet traffic processing for a virtual machine is changed.

In this regard, as shown in FIG. 3 above, in the edge platform according to an embodiment of the present disclosure, a virtual router may be configured to exist to support communication between a first virtual machine VM #1 and a second virtual machine VM #2, and an internal network configured to include the first virtual machine and the second machine, and a first edge gateway device LEG #1 and a second edge gateway device LEG #1 may be configured to exist to support Internet traffic processing of the first virtual machine VM #1 and the second virtual machine VM #2.

It is possible to recognize a routing event situation in which a specific floating IP address (233.39.6.3) is allocated to the first virtual machine VM #1 to support Internet traffic processing of the first virtual machine VM #1 in the edge platform as shown in FIG. 4 above, or a specific floating IP address (233.39.6.3) pre-allocated to the first virtual machine VM #1 is re-allocated to the second virtual machine VM #2 different from the first virtual machine VM #1 as shown in FIG. 5 above.

Here, the first edge gateway device LEG #1 may be configured to be identified as the edge gateway device 200 configured to process Internet traffic for the first virtual machine VM #1 and the second virtual machine VM #2.

Furthermore, as shown in FIG. 6 above, a case in which the edge gateway device 200 configured to support Internet traffic processing of the first virtual machine VM #1 is changed from the first edge gateway device LEG #1 to the second edge gateway device LEG #2 due to a failure or the like may be recognized as a routing event situation as well.

In this case, the second edge gateway device LEG #2 may be configured to be identified as the edge gateway device 200 configured to process Internet traffic for the first virtual machine VM #1.

Thereafter, when the edge gateway device 200 configured to process Internet traffic for a virtual machine is identified according to a routing event occurrence in the edge platform, the management part 120 is configured to transfer an event message according to a routing event to a switch in the edge platform through the identified edge gateway device 200 and update a routing table L2 Table being managed for routing Internet traffic by the switch, on the basis of the event message.

Here, the management part 120 may be configured to transfer, as an event message to update the routing table L2 Table being managed by the switch, a gratuitous ARP (GARP) message capable of updating information recorded in the message with a MAC address and an IP address in a message field, to the switch in the edge platform.

For better understanding, the updating procedure of the routing table L2 Table according to a type of a routing event will be described in detail below.

With respect to the routing event situation in which a specific floating IP address (233.39.6.3) is allocated to the first virtual machine VM #1 to support Internet traffic processing of the first virtual machine VM #1 in the edge platform, as shown in FIG. 4 above, it is possible to assume a case in which the first edge gateway device LEG #1 for Internet traffic processing of the first virtual machine VM #1 is identified.

In this case, by transferring a corresponding event message to the switch (physical switch) through the first edge gateway device LEG #1, the switch (physical switch) may be caused to map a specific floating IP address (233.39.6.3) and a MAC address of the first virtual machine VM #1 within the routing table L2 Table being managed.

Furthermore, it is possible to assume a routing event situation in which a specific floating IP address (233.39.6.3) pre-allocated to the first virtual machine VM #1 in the edge platform is re-allocated to the second virtual machine VM #2 different from the first virtual machine VM #1 as shown in FIG. 5 above.

Here, in case that the second edge gateway device LEG #1 for Internet traffic processing of the second virtual machine VM #2 is identified, a corresponding event message may be configured to be transferred to the switch (physical switch) through the first edge gateway device LEG #1, and therethrough, the switch (physical switch) may be caused to update a MAC address mapped to a specific floating IP address (233.39.6.3) within the routing table L2 Table being managed from the MAC address of the first virtual machine VM #1 to the MAC address of the second virtual machine VM #2.

It is possible to assume a case in which an event message is not transferred to a switch (physical switch) with respect to a routing event situation in which a specific floating IP address (233.39.6.3) pre-allocated to the first virtual machine VM #1 in the edge platform is re-allocated to the second virtual machine VM #2 different from the first virtual machine VM #1.

In this case, since the MAC address mapped to the specific floating IP address (233.39.6.3) is still considered as the MAC address of the first virtual machine VM #1 in the switch (physical switch), it may be predicted that packet drop is incurred and then Internet traffic for the second virtual machine VM #2 may be processed normally only after the existing information in the routing table is deleted by a timer (ARP timer) of the switch (physical switch) itself.

Furthermore, as shown in FIG. 6 above, it is also possible to assume an event situation in which the edge gateway device 200 configured to support Internet traffic processing of the first virtual machine VM #1 is changed from the first edge gateway device LEG #1 to the second edge gateway device LEG #2 due to a failure or the like.

Here, by transferring a corresponding event message for the situation to a switch (physical switch) through the second edge gateway device LEG #2, the switch (physical switch) may be caused to update the edge gateway device 200 configured to support Internet traffic processing of the first virtual machine VM #1 and the second virtual machine #2 within the routing table L2 Table being managed from the first edge gateway device LEG #1 to the second edge gateway device LEG #2.

As described above, according to the operating method of the edge platform management device 100 according to an embodiment of the present disclosure, a new connection method using the event message (GARP message) for connection between the L2-based switch and the edge gateway device 200 which is the L3-based traffic-processing gateway node in the mobile-edge computing (MEC) environment can be suggested and it may be seen that efficient response to changes in routing paths related to Internet traffic processing is possible without applying the existing L3-based routing protocol.

The operating method of the edge platform management device 100 according to an embodiment of the present disclosure may be implemented in a form of program command that may be configured to be executed through various computer means and recorded on a computer readable medium. The computer readable medium may include program commands, data files, data structures, etc. alone or in combination. Program commands recorded on the medium may be specially designed and configured for the present disclosure or known and usable to those skilled in computer software. Examples of computer-readable recording media include magnetic media such as hard disks, floppy disks, and magnetic tapes, optical media such as CD-ROMs and DVDs, magneto-optical media such as floptical disks, and hardware devices specially configured to store and execute program commands, such as ROM, RAM, flash memory, and the like. Examples of program commands include high-level language codes that may be executed by a computer using an interpreter, as well as machine language codes produced by a compiler. The aforementioned hardware device may be configured to function as one or more software modules to perform the operations of the present disclosure, and vice versa.

Although the present disclosure has been described in detail with reference to preferred embodiments, the present disclosure is not limited to the above-described embodiments, and the technical idea of the present disclosure extends to the extent that any person with ordinary knowledge in the technical field to which the present disclosure belongs may make various changes or modifications without departing from the gist of the present disclosure claimed in the following claims.

1. An edge platform management device comprising:
an identification part configured to identify, when a routing event occurs in relation to Internet traffic-processing of a virtual machine (VM) in an edge platform, an edge gateway device for processing Internet traffic for the virtual machine; and
a management part configured to transfer, through the edge gateway device, an event message according to the routing event to a switch for routing Internet traffic in the edge platform, thereby a routing table of the switch for a routing operation being updated based on the event message.

2. The edge platform management device of claim 1, wherein the routing event comprises an event in which a specific floating IP address is allocated to a first virtual machine in order to support Internet traffic-processing of the first virtual machine in the edge platform, or an event in which the specific floating IP address allocated to the first virtual machine is re-allocated to a second virtual machine.

3. The edge platform management device of claim 2, wherein the management part is configured to map the specific floating IP address and a MAC address of the first virtual machine within the routing table or update a MAC address mapped to the specific floating IP address from the MAC address of the first virtual machine to a MAC address of the second virtual machine based on the event message.

4. The edge platform management device of claim 1, wherein the routing event comprises an event in which an edge gateway device for processing Internet traffic for the virtual machine is changed from a first edge gateway device to a second edge gateway device.

5. The edge platform management device of claim 4, wherein the management part is configured to transfer the event message through the second edge gateway device to update an edge gateway device for processing Internet traffic of the virtual machine from the first edge gateway device to the second edge gateway device within the routing table.

6. The edge platform management device of claim 1, wherein the event message comprises a gratuitous ARP (GARP) message that updates information in the routing table using a MAC address and an IP address in a message field.

7. An edge gateway device configured to, when a routing event occurs in relation to Internet traffic-processing of a virtual machine (VM) in an edge platform, transfer an event message according to the routing event received from an edge platform management device to a switch and cause the switch to update a routing table being managed for a routing operation based on the event message.

8. The edge gateway device of claim 7, wherein the routing event comprises at least one of an event in which a specific floating IP address is allocated to a first virtual machine in order to support Internet traffic-processing of the first virtual machine in the edge platform, or the specific floating IP address allocated to the first virtual machine is re-allocated to a second virtual machine and an event in which a device for processing Internet traffic for the virtual machine is changed from another edge gateway device to the edge gateway device.

9. An operating method of an edge platform management device, the method comprising:
identifying, when a routing event occurs in relation to Internet traffic-processing of a virtual machine in an edge platform, an edge gateway device for processing Internet traffic for the virtual machine; and
transferring, through the edge gateway device, an event message according to the routing event to a switch for routing Internet traffic in the edge platform, thereby a routing table of the switch for a routing operation being updated based on the event message.

10. The operating method of claim 9, wherein the routing event comprises an event in which a specific floating IP address is allocated to a first virtual machine in order to support Internet traffic-processing of the first virtual machine in the edge platform, or an event in which the specific floating IP address allocated to the first virtual machine is re-allocated to a second virtual machine.

11. The operating method of claim 10, wherein in the management operation, the specific floating IP address and a MAC address of the first virtual machine are mapped within the routing table or a MAC address mapped to the specific floating IP address is updated from the MAC address of the first virtual machine to a MAC address of the second virtual machine based on the event message.

12. The operating method of claim 9, wherein the routing event comprises an event in which an edge gateway device for processing Internet traffic for the virtual machine is changed from a first edge gateway device to a second edge gateway device different from the first edge gateway device.

13. The operating method of claim 12, wherein the transferring comprises:
transferring the event message through the second edge gateway device to update an edge gateway device for processing Internet traffic of the virtual machine from the first edge gateway device to the second edge gateway device within the routing table.

14. The operating method of claim 9, wherein the event message comprises a gratuitous ARP (GARP) message that updates information in the routing table using a MAC address and an IP address in a message field.

15. A program configured to be stored in a medium and combined with hardware to execute each operation of claim 9.
